(19) United States
(12) Patent Application Publication
(10) Pub. No.: US 2014/0325652 A1
(43) Pub. Date: Oct. 30, 2014

(54) DETECTION OF DEVICE TAMPERING

(71) Applicant: Uniloc Luxembourg S.A., Luxembourg (LU)

(72) Inventor: Craig S. Etchegoyen, Plano, TX (US)

(73) Assignee: UNILOC LUXEMBOURG S.A., Luxembourg (LU)

(21) Appl. No.: 14/201,612

(22) Filed: Mar. 7, 2014

Related U.S. Application Data
(60) Provisional application No. 61/816,133, filed on Apr. 25, 2013.

(51) Int. Cl. H04L 29/06

(52) U.S. Cl. CPC H04L 63/1408
USPC 726/23

(57) ABSTRACT

A device such as a network appliance compares reference device attributes of the device obtained during manufacture to attributes of the device sampled at start-up to determine whether the device has been tampered with since manufacture. At manufacture, attributes of components of the device are measured, including attributes not normally measurable after manufacture. Upon initial power up in the field, the device measures the same attributes and compares the resulting measurements to the corresponding attribute values measured at manufacture. If any attribute has changed, the device determines that it may have been modified or tampered with and so indicates.

This application claim priority to U.S. Provisional Application 61/816,133, filed Apr. 25, 2013, which is fully incorporated herein by reference.

### BACKGROUND OF THE INVENTION

1. Field of Invention

The present invention relates generally to network-based computer security and, more particularly, methods of and systems for detecting tampering of a device such as a network appliance.

2. Description of the Related Art

Cyber warfare, namely, actions by a nation-state to penetrate another nation's computers or networks for the purposes of causing damage or disruption, has become a reality and a serious threat to national security around the world. Similarly, corporate cyber espionage is a serious threat to organizations and markets globally. As a result, most computers used in governments and by corporations in areas of sensitive information are typically heavily protected from attack.

At the same time, governments and large organizations are generally under constant pressure to reduce costs. As a result, much of the computer networking hardware, particularly network appliances such as routers, switches, and access points, for example, is purchased in bulk from wholesale distributors. Generally, such network appliances do not accept logic received through a network to modify behavior of the appliances without careful authentication by a system administrator with authorization to make such changes. However, a distributor in physical possession of such network appliances can modify the logic controlling the behavior of those network appliances. Such would allow the distributor to open a door into an otherwise secured network through the modified network appliances. If the distributor could replicate tamper-evident packaging, the tampering of the network appliances would go undetected.

What is needed is a way to determine whether a network appliance has been tampered with since manufacture.

### SUMMARY OF THE INVENTION

In accordance with the present invention, a device such as a network appliance compares reference device attributes of the device obtained during manufacture to attributes of the device sampled at start-up to determine whether the device has been tampered with since manufacture. The device includes authentication logic that is stored in readonly memory and that can access any attributes of various components of the device.

At manufacture, attributes of components of the device are measured, including attributes not normally measurable after manufacture. For example, attributes can be measured with an attached Joint Test Action Group (JTAG) device or other logic implement the JTAG testing protocol. As used herein, “at manufacture” means prior to sealing of the assembled device in packaging by the manufacture to delivery. The authentication logic is configured to be able to measure the same attributes, e.g., using the Joint Test Action Group (JTAG) testing protocol. The authentication logic and authentication data representing the attributes measured at manufacture are written to readonly memory in the device at manufacture.

Upon initial power up, the authentication logic measures the same attributes and compares the resulting measurements to the corresponding attribute values measured at manufacture. Since the device should not have been used at all since it left the manufacture, all attributes should measure exactly the same at manufacture and at first field use, even if a given attribute measurement can change over periods of prolonged use of the device.

If a newly measured attribute of any component of the device has changed from the value measured at manufacture, the authentication logic determines that the device may have been modified or tampered with. This determination can be communicated to a human operator using an indicator, such as an LED whose on/off state communicates whether the device is in its original state for example. The determination can also be made remotely using a device authentication server, maintained for example by the device manufacturer, that receives from the device the measured attributes at startup for comparison against the corresponding attribute values measured and stored locally at the server at the time of manufacture. The determination can be communicated to the human operator via network transmission to the device or through a communication means independent of the device.

All components that are capable of modifying the behavior of the device are authenticated. Such components include components that contain logic defining at least a part of the behavior of the device, e.g., a boot ROM, and components capable of writing to any memory storing logic that defines at least a part of the behavior of the device.

Thus, when a human operator is to put the device into service in the field, the operator can observe the indicator to determine whether the device may have been modified or tampered with. Modification or tampering with any component of the device that is capable of modifying the behavior of the device is detected and indicated.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a network appliance, between a private network and a wide area network, and a server that cooperate to verify that the network appliance is in an original state in accordance with one embodiment of the present invention.

FIG. 2 is a block diagram showing in greater detail the network appliance of FIG. 1.

FIG. 3 is a block diagram of a component record used by the network appliance to verify that the network appliance is in an original state.

FIG. 4 is a logic flow diagram illustrating the manner in which the network appliance verifies that the network appliance is in an original state.

### DETAILED DESCRIPTION

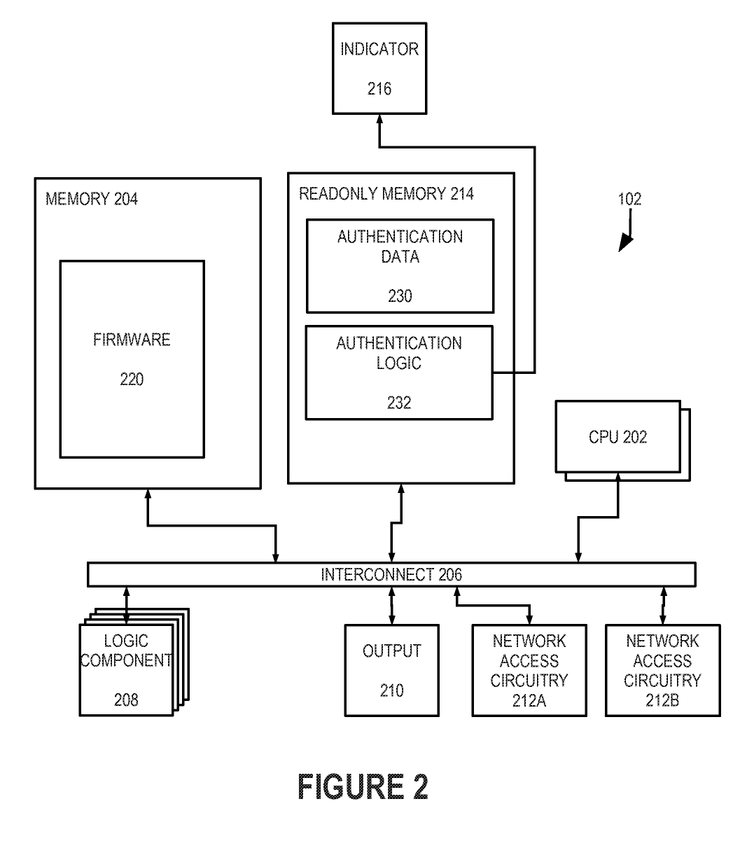

In accordance with the present invention, a device 102 such as a network appliance compares reference device attributes of device 102 obtained during manufacture to attributes of device 102 sampled at start-up to determine whether device 102 has been tampered with since manufacture. Generally, device 102 includes authentication logic 232 (FIG. 2) that is stored in readonly memory 214 and that can access any attributes of device 102 through the Joint Test Action Group (JTAG) testing protocol. Authentication data 230 is determined at manufacture and stored in readonly memory 214. Authentication logic 232 uses authentication data 230 to determine whether any components of device 102 have changed since manufacture.

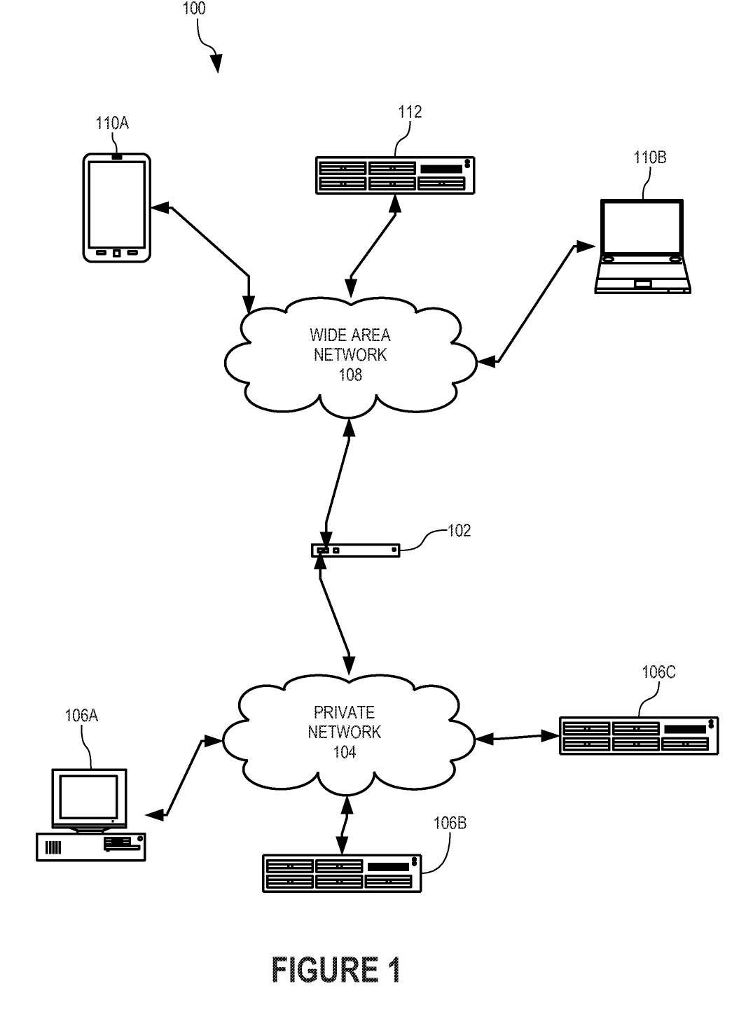

In this illustrative embodiment, device 102 (FIG. 1) is a router and is connected between private network 104 and a wide area network 108. In this illustrative embodiment, wide area network 108 is the Internet. Device 102 is configured in this illustrative example to restrict access by devices such as devices 110A-B through wide area network 108 to private network 104 and therethrough to devices 106A-C. Devices 106A-C may contain sensitive information that is to be guarded, at least in part, by device 102.

Device 102 is shown in greater detail in FIG. 2. Device 102 includes one or more microprocessors 202 (collectively referred to as CPU 202) that retrieve data and/or instructions from memory 204 and execute the retrieved instructions in a conventional manner. Memory 204 can include generally any computer-readable medium including, for example, persistent memory such as magnetic and/or optical disks, ROM, and PROM and volatile memory such as RAM.

CPU 202 can also retrieve data and/or instructions from readonly memory 214 and execute the retrieved instructions in a conventional manner. Readonly memory 214 can only be read and cannot be written to. Readonly memory 214 can be formed in a portion of memory 204 by writing data to readonly memory 214 at manufacture and then physically disabling address pins required to write to the portion at manufacture. As a result, that portion of memory 204 used for readonly memory 214 cannot be modified after manufacture. In addition, any of a wide variety of WORM (Write Once, Read Many) storage technologies can be used for readonly memory 214.

Device 102 also includes a number of logic components 208, each of which defines or is capable of defining at least a part of the behavior of device 102. Logic components 208 (i) can store instructions to be retrieved and executed by CPU 202 and can be implemented at least in part as logic implemented in electronic circuitry or (ii) can write to memory 204 and can therefore modify firmware 220. Logic components 208 include a boot ROM of device 102.

CPU 202 and memory 204 are connected to one another through a conventional interconnect 206, which is a bus in this illustrative embodiment and which connects CPU 202 and memory 204 to logic components 208, output devices 210, and network access circuitry 212A-B. Output devices 210 can include, for example, a display—such as a liquid crystal display (LCD)—and one or more LED indicators and one or more loudspeakers. Network access circuitry 212A sends and receives data through computer networks such as private network 104 (FIG. 1). Network access circuitry 212B sends and receives data through computer networks such as wide area network 108.

Firmware 220 is stored in memory 204 and includes logic that defines much, if not all, of the behavior of device 102. As used herein, “logic” refers to (i) logic implemented as computer instructions and/or data within one or more computer processes and/or (ii) logic implemented in electronic circuitry.

Authentication data 230 and authentication logic 232 are stored in readonly memory 214. and that can access any attributes of device 102 through the Joint Test Action Group (JTAG) testing protocol. Authentication data 230 is determined at manufacture from various components of device 102. Authentication data 230 can be formed using any discoverable attributes of device 102, including attributes discoverable only through testing such as JTAG testing. Authentication logic 232 uses authentication data 230 to determine whether any components of device 102 have changed since manufacture in a manner described more completely below.

In one embodiment, authentication logic 232 has direct and sole control of an indicator 216, which is an LED in this illustrative embodiment. Indicator 216 indicates whether device 102 is in its original state. Since authentication logic 232 has direct and sole control of indicator 216, modification of firmware 220 or any of logic components 208 cannot spoof a tamper-free condition through control of indicator 216.

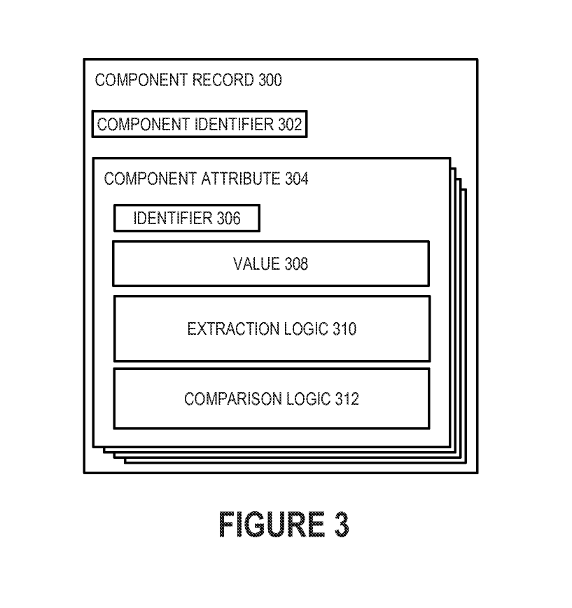

Authentication data 230 includes a number of component records such as component record 300 (FIG. 3). Component record 300 corresponds to a particular component of device 102, such as memory 204 (FIG. 2), firmware 220, or any of logic components 208 for example. In this illustrative embodiment, authentication data 230 includes a component record for each and every component of device 102 that is capable of modifying the behavior of device 102, including a boot ROM and any components of device 102 that are capable of writing to memory 204. The particular component represented by component record 300 is sometimes referred to as “the subject component.”

Component identifier 302 identifies the subject component. Component attributes 304 each define a respective attribute of the subject component that, in part, identifies and authenticates the subject component. The particular attribute represented by component attribute 304 is sometimes referred to “the subject attribute.”

Identifier 306 of component attribute 304 identifies the subject attribute. Value 308 of component attribute 304 specifies the value of the subject attribute as measured during manufacture. Extraction logic 310 of component attribute 304 specifies the manner in which authentication logic 232 (FIG. 2) extracts the subject attribute from the subject component. Comparison logic 312 (FIG. 3) of component attribute 304 specifies the manner in which authentication logic 232 (FIG. 2) compares the extracted attribute with value 308. In this illustrative embodiment, comparison logic 312 requires a perfect match of the results of extraction logic 310 with value 308 for all attributes since authentication logic 232 (FIG. 2) is to indicate that there has been no use whatsoever of device 102 since it left the manufacturer.

Examples of attributes include electronic serial numbers, hashes of data stored by the component, and generally any measurable or determinable state of the component that can be determined by authentication logic 232, including access through a JTAG interface. Examples include internal damage maps of any non-movable memory (e.g., flash memory) and the exact cycle time of any processor of CPU 202. During manufacture, extraction logic 310 (FIG. 3) is performed by an attached JTAG tester or other logic, extracting information of the subject component. Extraction logic 310 can include test input data/instructions for a JTAG test of the subject component and the test results can be stored as value 308.

Once all component records have been created, including execution of extraction logic 310 to produce value 308 of all component records, the component records are recorded, along with authentication logic 232, into readonly memory 214. As described above, readonly memory 214 can use any of a number of WORM technologies to write authentication data 230 and authentication logic 232 once and prevent any subsequent writing to readonly memory 214.

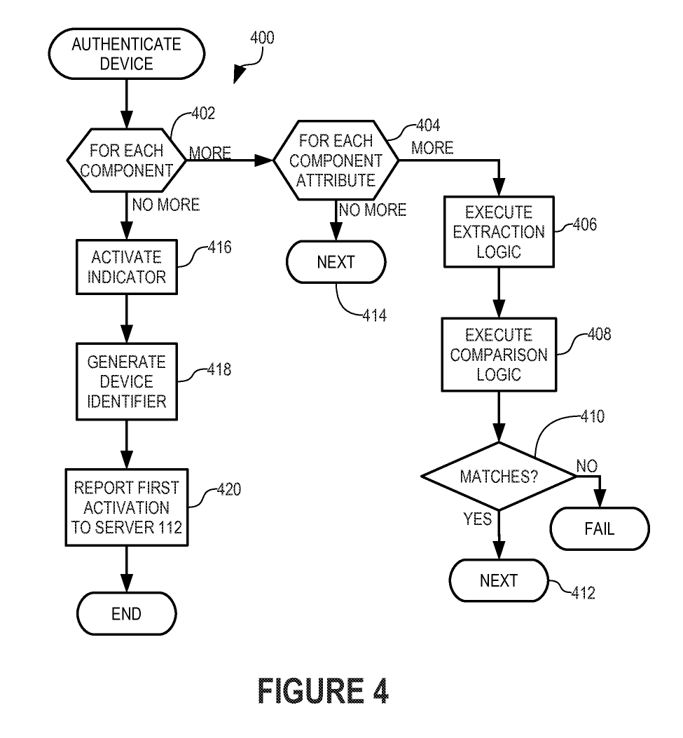

When first powered on and prior to executing any other logic, device 102 causes authentication logic 232 (FIG. 2) to test for tampering in the manner illustrated by logic flow diagram 400 (FIG. 4). Loop step 402 and next step 414 define a loop in which authentication logic 232 processes each of a number of component records such as component record 300 (FIG. 3) according to steps 404-412 (FIG. 4). During a given iteration of the loop of steps 402-414, the particular component record processed by authentication logic 232 is sometimes referred to as “the subject component record.”

Loop step 404 and next step 412 define a loop in which authentication logic 232 processes each of the component attributes such as component attributes 304 (FIG. 3) of the subject component record according to steps 406-410 (FIG. 4). During a given iteration of the loop of steps 402-414, the particular component attribute processed by authentication logic 232 is sometimes referred to as “the subject component attribute.”

In step 406, authentication logic 232 executes extraction logic 310 (FIG. 3) of the subject component attribute to obtain resulting component attribute data. In step 408 (FIG. 4), authentication logic 232 executes comparison logic 312 (FIG. 3) of the subject component attribute to determine whether the component attribute data obtained in step 406 (FIG. 4) matches value 308 (FIG. 3) of the subject component attribute.

If the component attribute data does not match value 308, processing by authentication logic 232 transfers through test step 410 (FIG. 4) and completes, never reaching steps 416-418, which indicate that device 102 is in an original state as manufactured and which are described more completely below. Conversely, if the component attribute data matches value 308 (FIG. 3), processing by authentication logic 232 transfers through test step 410 (FIG. 4), through next step 412 to loop step 404, and authentication logic 232 processes the next component attribute of the subject component record according to the loop of steps 404-412.

Once all component attributes of the subject component record have been processed by authentication logic 232 according to the loop of steps 404-412, processing by authentication logic 232 transfers through next step 414 to loop step 402, and authentication logic 232 processes the next component record according to the loop of steps 402-414. Once all component records have been processed by authentication logic 232 according to the loop of steps 402-414, processing by authentication logic 232 transfers to step 416.

It should be noted that, in this illustrative embodiment, processing by authentication logic 232 only reaches step 416 if execution of comparison logic 312 for each and every component attribute for each and every component indicates a match. Accordingly, at step 416, authentication logic 232 has identified no change in state of any component since device 102 was manufactured and therefore that device 102 is in its original state and has not been tampered with. In step 416, authentication logic 232 activates indicator 216 (FIG. 2). Indicator 216 is controlled exclusively by authentication logic 232 and directly, i.e., by direct and exclusive connection between authentication logic 232 and indicator 216.

Therefore, when device 102 is first powered on, a human operator can watch for activation of indicator 216 before connecting device 102 to any network. In this illustrative embodiment, authentication logic 232 causes indicator 216 to blink during performance of steps 402-414 to indicate that detection of tampering is in process. Absence of activation of indicator 216 indicates that device 102 is no longer in its original state.

As noted above, it is possible that extract logic 310 (FIG. 3) for various component attributes measure characteristics that may change over prolonged periods of use of device 102. Accordingly, indicator 216 may eventually not activate even though device 102 has not been modified. The primary purpose of indicator 216 is to indicate the absence of tampering or modification of device 102 upon initial use in the field and is not intended to be a reliable indicator of absence of modification thereafter.

In step 418 (FIG. 4), authentication logic 232 generates a device identifier from component attribute data obtained in various performances of step 406. In step 420, authentication logic 232 reports the first field use of device 102 to server 112 (FIG. 1) using the identifier. Server 112 identifies device 102 by comparing the received device identifier to identifiers created from device component attributes measured during manufacture using the same process used by authentication logic 232 in step 418. When the report of step 420 is received by server 112, server 112 records the date and time of first activation of device 102.

Server 112 provides a web-based service whereby people can enter a serial number or other identifier of device 102 and receive information specifying the date and time of first field use of device 102. Thus, even if someone with malicious intent and access to device 102 prior to delivery to the retail purchaser opens the casing of device 102 and installs a fake replacement for indicator 216, the purchaser can verify the date and time of first field use of device 102 through server 112. If the date and time of first field use of device 102 is reported by server 112 to be prior to delivery, device 102 may have been modified and indicator 216 may have been faked. If server 112 reports no date and time of first field use of device 102, authentication logic 232 has not performed step 420 and may have been modified or removed.

In another embodiment, in lieu of or in addition to illuminating an indicator 216, authentication logic 232 executes instructions to cause device 102 to transmit the device identifier to server 112. Server 112 may function as an authentication server, by comparing the received device identifier to a list of stored identifiers, each taken from a device at its time of manufacture and before being released into commerce in the same manner described above. If the comparison yields a match, server 112 may communicate a positive result to the device 102, to confirm first usage of the device to the human operator either through display on a user interface of the device or via illumination of the indicator 216. Alternatively, or in addition, verification of first usage of device 102 may be communicated between server 112 and the human operator of device 102 by some independent means. For example, verification of passage or failure of the first-usage test may be communicated by a telephone call or other electronic transmission from the server or its operator to a receiver specified by the human operator of device 102, to achieve a higher level of security.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

1-10. (canceled)

11. A device comprising:
at least one processor;
a computer readable medium that is operatively coupled to the processor;
network access circuitry that is operatively coupled to the processor; and
authentication logic (i) that executes at least in part in the processor from the computer readable medium and (ii) that, when executed, causes the processor to detect modification of the device by at least:
for each of one or more components of the device:
measuring one or more characteristics of the component that are capable of modifying the behavior of the device; and
comparing the characteristics of the component to corresponding predetermined reference characteristics of the component that are measured at manufacture of the device; and
determining that the device may have been modified after manufacture upon a condition in which at least one characteristic does not match the corresponding reference characteristic for at least one component.

12. The device of claim 11 wherein the authentication logic is configured to cause the processor to identify a remotely located device by at least also:
using an indicator to indicate to a human operator upon determining that the device may have been modified after manufacture.

13. The device of claim 11 or 12 wherein measuring comprises:
applying one or more tests to the component according to a circuit test protocol.

14. The device of any one of claims 11 to 13 wherein the one or more components of the device include every component of the device that is capable of modifying the behavior of the device.

15. The device of any one of claims 11 to 13 wherein the one or more components of the device include a boot ROM of the device.
